(19) United States
(12) Patent Application Publication
(10) Pub. No.: US 2009/0038902 A1
(43) Pub. Date: Feb. 12, 2009

(54) Method of providing electricity to a moving automobile

(76) Inventor: Sitaramarao Srinivas Yechuri, Lake Forest, CA (US)

Correspondence Address: Sitaramarao Srinivas Yechuri, 203 Hamilton Ave, Apt 2D, Staten Island, NY, 10301, US

(21) Appl. No.: 11/890,443

(22) Filed: Aug. 7, 2007

(51) Int. Cl. B60L 5/38; B60L 9/00; E01C 1/00

(52) U.S. Cl. 191/48; 404/1; 701/22

(57) ABSTRACT

This invention describes a new method of supplying a moving automobile with electricity. Electrodes placed beneath the automobile pass over electrodes embedded in the roadway. The capacitance between the electrodes beneath the car and the electrodes embedded in the roadway closes the circuit and high voltage pulses or a high voltage sinusoidal signal is transferred from the electrodes in the roadway to the electrodes beneath the car. This power is used to charge the car batteries. Hence the charging occurs while the automobile is in motion so that the automobile can travel from city to city without ever stopping.

### TECHNICAL FIELD OF THE INVENTION

This invention relates generally to recharging a battery used in an electric or hybrid vehicle while it is moving on the highway.

### SUMMARY OF THE INVENTION

This invention describes a new method of supplying a moving automobile with electricity. Electrodes placed beneath the automobile pass over electrodes embedded in the roadway. The capacitance between the electrodes beneath the car and the electrodes embedded in the roadway closes the circuit and high voltage pulses or a high voltage sinusoidal signal is transferred from the electrodes in the roadway to the electrodes beneath the car. This power is used to charge the car batteries. Hence the charging occurs while the automobile is in motion so that the automobile can travel from city to city without ever stopping.

### BRIEF DESCRIPTION OF THE DRAWINGS

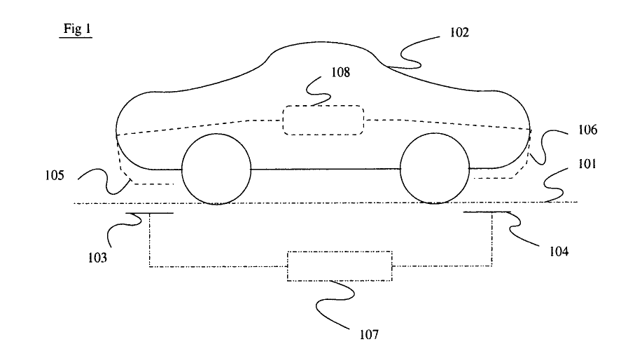

One possible embodiment of this invention is shown in the figure FIG. 1. In this figure, the roadway is marked as 101 and there is a car 102 on the roadway. Two flat plate electrodes 103 and 104 are embedded in the roadway. They are connected to the pulsed power circuit 107.

Beneath the car are attached two electrodes 105 and 106. They are connected to a circuit 108. When the car travels over the roadway the two electrodes 105 and 106 pass over the electrodes 103 and 104. Suppose that the electrodes 103 and 104 are square, 3 cm on the side. Let the electrodes 105 and 106 be 20 cm on the side. Now, suppose the car is traveling at 75 Miles per hour i.e. 33.33 M/s. It will take the electrode 105 approximately 6 milliseconds to pass over the electrode 103.

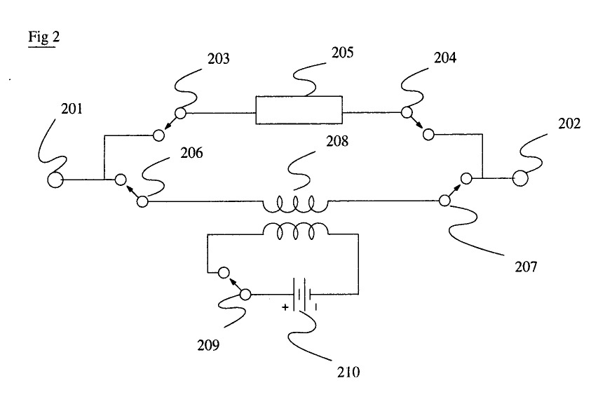

This 6 milliseconds is when the power transfer from the circuit under the highway to the car battery takes place. Assume that the pulsed power circuit 107 is comprised of the circuit shown in the figure FIG. 2. The electrode 201 in the figure FIG. 2 is connected to the electrodes 105 in the figure FIG. 1. The electrode 202 in the figure FIG. 2 is connected to the electrodes 106 in the figure FIG. 1.

Initially the switches 203 and 204 are closed while the switches 206 and 207 are open. The circuit 205 transmits a signal including an identification, perhaps even a credit card number (encrypted of course). As the electrodes 105 and 106 pass over the electrodes 103 and 104 respectively, the signal is recognized and validated, and the power transmission is initiated by opening switches 203 and 204 and closing switches 206, 207 and 209.

Now the circuit 107 fires high voltage pulses with 103 as high and 104 as low (i.e. ground). Now if the electrodes 105 and 106 are separated by about 2 cm from the electrodes 103 and 104 respectively, then the capacitance between the electrodes 103 and 105 and between 104 and 106 is about 2 pico-Farad. Now suppose that the inductance of the primary of the step-down transformer 208 is about 2 micro-Henry. Now for power pulses of about 1 ns width, the majority of the voltage is dropped across the inductance of the primary of the step-down transformer 208. This voltage causes current to flow through the secondary of 208, thus charging the battery 210. Alternately, a sinusoidal voltage of a few kilo-Volts amplitude shifted up by half the peak to peak voltage can be used in place of pulses, so that you have a single frequency of a few giga-Hertz. Also, in place of the switch 209, one could use a reverse-biased diode. Or the battery 210 can be connected to the secondary of 208 through a rectification circuit. The ground side of the circuit could traverse much of the length of the automobile, so as to avoid charging the car body itself.

So the entire transaction is completed while the electrodes 105 and 106 pass over the electrodes 103 and 104 respectively, and then as the car travels down the highway, more transactions take place, thus keeping the car batteries fully charged. These transactions are initiated by the circuit 205, so the charging is controlled by the car.

There are several facts that should be obvious to anyone trained as an electrical engineer. For example it should be obvious that all the electrodes placed under the car and embedded under the road in this patent application can be covered with insulator. Covering the electrodes with insulator will not significantly affect the capacitance between the electrodes under the road and the electrodes under the car and the only affect of such a change in capacitance would be to change the oscillation frequency at which the loop impedance is at it's minimum.

It should be obvious to anyone trained as an electrical engineer that this technology can be used to make toy automobiles traveling upon toy roadways in just the same way as it can be applied to a real automobile traveling upon real roadways. After all a toy automobile is just a real automobile which is reduced in size.

It should be obvious to anyone trained as an electrical engineer that this technology can be used for any type of automotive vehicle, even an automotive vehicle that runs on tracks such as a locomotive. The fact that a locomotive runs on tracks (also called rails) has no relevance to this patent application so a locomotive is just another automobile i.e. a self-propelled vehicle.

It should be obvious to anyone trained as an electrical engineer that the circuit used in this patent application could be operated at or near resonance. Resonance is a phenomenon described in most textbooks on the subject of circuit theory. Similarly the circuit could operate in an under-damped oscillation mode. This too is described in most textbooks on the subject of circuit theory. The purpose of doing this is to maximize the power transfer from the oscillator under the roadway to the circuit inside the automobile.

It should be obvious to anyone trained as an electrical engineer that the inductance of the coils of the motors used in the automobile or the inductance of the coils of a transformer used in the automobile may be a portion of the inductance placed in series with the capacitances between the electrodes placed under the car and the electrodes embedded under the road to cause the oscillation used in the circuit of this patent application.

It should be obvious that the frequency of operation of the circuit and hence the values of the inductances used aboard the automobile could be chosen so that the oscillations meet the FCC requirements. So the operating frequency could be as low as a few mega Hertz.

It should be obvious to anyone trained as an electrical engineer that the electrodes placed under the car and embedded under the road could be placed in alternate configurations such as parallel to each other i.e. one toward the left and the other toward the right of the line dividing the car along the direction of motion of the automobile.

What is claimed is:

1. A method and apparatus for transferring electricity to an automobile comprising of:
one or more electrodes embedded in the roadway
a corresponding set of electrodes attached beneath the automobile
pulses of electricity transmitted from the electrodes in the roadway to the corresponding electrodes beneath the automobile via the capacitance between the electrodes in the roadway and the corresponding electrodes beneath the automobile

2. the method of claim 1 where—in the automobile body acts as one of the electrodes

3. the method of claim 1 where—in the roadway acts as one of the electrodes i.e. the ground electrode

4. the method of claim 1 where—in a signal sent from the electrodes beneath the automobile to the electrodes in the roadway as the automobile passes over them initiates the start of the transmission of the pulses of electricity

5. the method of claim 4 where—in the signal contains identification information

6. the method of claim 4 where—in the signal contains payment information

7. the method of claim 1 where—in the electrodes beneath the automobile are lowered closer to the roadway to increase the capacitance between the them and the corresponding electrodes embedded in the roadway

8. the method of claim 1 where—in the impedance detected between the electrodes in the roadway determines whether the circuit is completed and ready for the initiation of transmitting the pulses of electricity

9. the method of claim 1 where—in the pulses of electricity are replaced by a continuous sinusoidal voltage pattern.
